(19) United States
(12) Patent Application Publication
(10) Pub. No.: US 2022/0393993 A1
(43) Pub. Date: Dec. 8, 2022

(54) INFORMATION PROCESSING APPARATUS, INFORMATION PROCESSING SYSTEM, INFORMATION PROCESSING METHOD, AND PROGRAM

(71) Applicant: SONY GROUP CORPORATION, TOKYO (JP)

(72) Inventors: RITSUKO KANO, TOKYO (JP); EIJIRO MORI, TOKYO (JP)

(21) Appl. No.: 17/755,056

(22) PCT Filed: Oct. 19, 2020
(86) PCT No.: PCT/JP2020/039211

§ 371 Date: Apr. 20, 2022

(30) Foreign Application Priority Data
Oct. 28, 2019 (JP) 2019-195007

(51) Int. Cl. H04L 51/02; G10L 15/22; G06F 16/335; G06F 16/332

(52) U.S. Cl. CPC H04L 51/02; G10L 15/22; G06F 16/335; G06F 16/3329

(57) ABSTRACT

[Object] To propose an information processing apparatus, an information processing method, an information processing system, and a program that enable a user to check handover of information between an agent and an operator.

[Solving Means] An information processing apparatus according to the present technology is connected to be capable of communicating with a terminal apparatus of a user and a terminal apparatus of an operator who interacts with the user and has an agent that performs information exchange with the user about a specific topic. The information processing apparatus includes a control unit. The control unit causes the terminal apparatus of the user to display a situation where the agent is communicating a progress status of the information exchange to the operator.

### TECHNICAL FIELD

The present technology relates to an information processing apparatus, an information processing system, an information processing method, and a program.

### BACKGROUND ART

In recent years, apparatuses installing an agent that suggests a particular product and service in accordance with a request from a user have prevailed. For example, Patent Literature 1 has disclosed a technology of more naturally suggesting an appropriate choice to the user.

### CITATION LIST

### Patent Literature

Patent Literature 1: WO 2019/026396

### DISCLOSURE OF INVENTION

### Technical Problem

In suggesting particular information to the user via such an agent, in a case where the agent cannot deal with the user, an operator (humanity) may deal with it instead. In this case, the user cannot check handover of information from the agent to the operator or from the operator to the agent, and it may cause the user feel uneasy. In addition, the information may not be suitably communicated to the operator from the agent, and it may result in inefficient communication.

In view of this, the present disclosure will propose an information processing apparatus, an information processing system, an information processing method, and a program that enable a user to check handover of information between an agent and an operator.

### Solution to Problem

In order to solve the above-mentioned problem, an information processing apparatus according to an embodiment of the present technology is connected to be capable of communicating with a terminal apparatus of a user and a terminal apparatus of an operator who interacts with the user and has an agent that performs information exchange with the user about a specific topic.

The information processing apparatus includes a control unit.

The control unit causes the terminal apparatus of the user to display a situation where the agent is communicating a progress status of the information exchange to the operator.

The control unit may cause the agent to utter the progress status of the information exchange to the operator.

The control unit may receive audio information from the user while the agent is communicating the progress status to the operator by the utterance.

The control unit may determine whether or not to cause the agent to communicate the progress status to the operator on the basis of audio information regarding the specific topic from the user.

The control unit may cause, in a case where the control unit determines to cause the agent to communicate the progress status to the operator on the basis of the audio information regarding the specific topic from the user, to temporarily stop the information exchange and performs processing of shifting to a topic different from the specific topic.

The control unit may
cause the terminal apparatus of the user to display an avatar image of the agent and an avatar image of the operator, and
cause the terminal apparatus of the user to display a situation where the avatar image of the agent is communicating the progress status to the avatar image of the operator.

The control unit may cause the terminal apparatus of the operator to display at least one of a history of the information exchange between the user and the agent or information displayed on the terminal apparatus of the user during the information exchange between the user and the agent.

In order to solve the above-mentioned problem, an information processing system according to an embodiment of the present technology includes a terminal apparatus of a user, a terminal apparatus of an operator who interacts with the user, and an information processing apparatus.

The information processing apparatus is connected to be capable of communicating with the terminal apparatus of the user and the terminal apparatus of the operator and has an agent that performs information exchange with the user about a specific topic.

The information processing apparatus includes a control unit.

The control unit causes the terminal apparatus of the user to display a situation where the agent is communicating a progress status of the information exchange to the operator.

In order to solve the above-mentioned problem, in an information processing method for an information processing apparatus according to an embodiment of the present technology,
information exchange is performed with a user about a specific topic.

A terminal apparatus of the user is caused to display a situation where an agent is communicating a progress status of the information exchange to the operator.

In order to solve the above-mentioned problem, a program according to an embodiment of the present technology causes an information processing apparatus to execute the following steps.

A step of performing information exchange with a user about a specific topic.

A step of causing a terminal apparatus of the user to display a situation where an agent is communicating a progress status of the information exchange to the operator.

### BRIEF DESCRIPTION OF DRAWINGS

FIG. 1 A schematic diagram showing a configuration example of an information processing system according to the present technology.

FIG. 2 A block diagram showing a configuration example of an information processing apparatus of the information processing system.

FIG. 3 A block diagram showing a hardware configuration example of the information processing apparatus.

FIG. 4 A diagram showing an example of a display screen of a terminal apparatus of the information processing system.

FIG. 5 A flowchart showing an operation of the information processing system.

FIG. 6 A conceptual diagram showing respective interaction partners of a plurality of users in time series.

FIG. 7 A diagram showing examples of a display screen of a terminal apparatus of a user in the information processing system.

FIG. 8 A diagram showing examples of the display screen of the terminal apparatus of the user in the information processing system.

FIG. 9 A diagram showing examples of the display screen of the terminal apparatus of the user in the information processing system.

FIG. 10 A diagram showing examples of the display screen of the terminal apparatus of the user in the information processing system.

FIG. 11 A diagram showing examples of the display screen of the terminal apparatus of the user in the information processing system.

FIG. 12 A flowchart showing an operation of an information processing system according to a second embodiment of the present technology.

FIG. 13 A conceptual diagram showing respective interaction partners of a plurality of users in time series in the second embodiment of the present technology.

FIG. 14 A flowchart showing an operation of the information processing system.

FIG. 15 A conceptual diagram showing the respective interaction partners of the plurality of users in time series in the second embodiment of the present technology.

### MODE(S) FOR CARRYING OUT THE INVENTION

Hereinafter, embodiments of the present technology will be described with reference to the drawings.

### First Embodiment

[Configuration of Information Processing System]

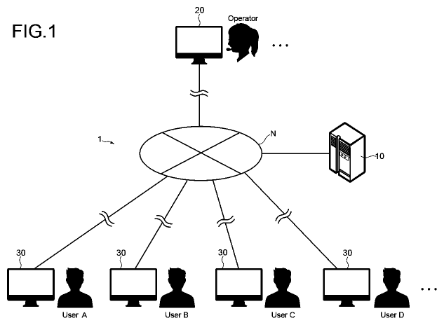

FIG. 1 is a diagram showing a configuration example of an information processing system 1 according to this embodiment. As shown in FIG. 1, the information processing system 1 includes an information processing apparatus 10, a terminal apparatus 20, and a plurality of terminal apparatuses 30.

The information processing apparatus 10 and the plurality of terminal apparatuses 20 and 30 are connected to be capable of communicating with each other via a network N. The network N may be the Internet, a mobile communication network, a local area network, or the like or may be a network combining a plurality of types of networks of them.

(Information Processing Apparatus)

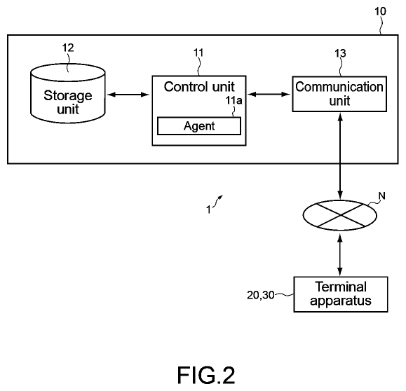

FIG. 2 is a block diagram showing a configuration example of the information processing apparatus 10. The information processing apparatus 10 includes a control unit 11, a storage unit 12, and a communication unit 13. The information processing apparatus 10 is typically a server apparatus, though not limited thereto. The information processing apparatus 10 may be any other computer such as a PC.

The control unit 11 controls general operations of the information processing apparatus 10 or some of the general operations in accordance with programs stored in the storage unit 12. The control unit 11 has an agent 11a. The agent 11a is an automation program for interpreting input information (e.g., utterance) from a user to thereby autonomously judge the user's intention and controlling the execution of processing according to the user's intention.

The storage unit 12 stores, about a topic having a preset difficulty level, sentences of inquiries and combinations of sentences of inquiries to the respective users and sentences of answers of the respective users, assuming the inquiries.

The storage unit 12 stores the details of the utterance of the agent 11a and the operator and information that the agent 11a has got from the user. The storage unit 12 stores an interaction history between the agent 11a and the operator. The storage unit 12 may store information regarding inquiries from the user, automatic responses of the agent 11a, and in addition, an interaction history between the user and the operator as chat information (log).

The communication unit 13 communicates with each of the plurality of terminal apparatuses 20 and 30 via the network N. The communication unit 13 functions as a communication interface of the information processing apparatus 10.

(Terminal Apparatus)

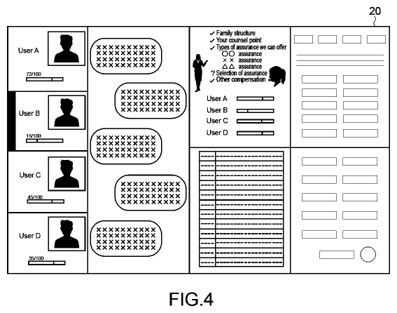

The terminal apparatus 20 is operated by the operator. FIG. 4 is a diagram showing an example of a display screen of the terminal apparatus 20. The display screen of the terminal apparatus 20 displays an interaction history between the user and the agent 11a and the operator. As this interaction history, for example, the details of the utterance of the agent 11a and the details of the utterance of the operator are displayed in a distinguished manner.

Moreover, the same screen as the screen displayed on the display screen of the terminal apparatus 30 is displayed as the display screen of the terminal apparatus 20. In addition, the information that the agent 11a has got from the user is presented on the display screen of the terminal apparatus 30.

The plurality of terminal apparatuses 30 deals with different users and receives utterances from the users, respectively. The terminal apparatuses 20 and 30 are typically personal computers (PC), though not limited thereto. The terminal apparatuses 20 and 30 may be any other computers such as smartphones and tablet terminals.

(Hardware Configuration)

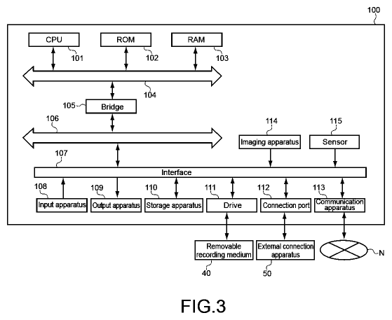

FIG. 3 is a block diagram showing a hardware configuration example of the information processing apparatus 10. The information processing apparatus 10 may be an information processing apparatus 100.

The information processing apparatus 100 has a central processing unit (CPU) 101, a read only memory (ROM) 102, and a random access memory (RAM) 103. The control unit 11 may be the CPU 101.

Moreover, the information processing apparatus 100 may be configured to have a host bus 104, a bridge 105, an external bus 106, an interface 107, an input apparatus 108, an output apparatus 109, a storage apparatus 110, a drive 111, a connection port 112, and a communication apparatus 113.

In addition, the information processing apparatus 100 may be configured to have, depending on needs, an imaging apparatus 114 and a sensor 115. The information processing apparatus 100 may include, instead of or in addition to the CPU 101, a processing circuit such as a digital signal processor (DSP), an application specific integrated circuit (ASIC), and a graphics processing unit (GPU).

The CPU 101 functions as an arithmetic processing apparatus and a control apparatus, and controls general operations in the information processing apparatus 100 or some of the general operations in accordance with various programs recorded in the ROM 102, the RAM 103, the storage apparatus 110, or a removable recording medium 40. The storage unit 12 may be the ROM 102, the RAM 103, the storage apparatus 110, or the removable recording medium 40.

The ROM 102 stores programs, operation parameters, and the like to be used by the CPU 101. The RAM 103 temporarily stores programs to be used in execution of the CPU 101, parameters to be changed as appropriate in the execution, and the like.

The CPU 101, the ROM 102, and the RAM 103 are connected to one another via the host bus 104 constituted by an internal bus such as a CPU bus. In addition, the host bus 104 is connected to the external bus 106 such as a peripheral component interconnect/interface (PCI) bus via the bridge 105.

The input apparatus 108 includes, for example, an apparatus that the user operates, such as a mouse, a keyboard, a touch panel, a button, a switch, a lever, and the like. The input apparatus 108 may be, for example, a remote control apparatus utilizing infrared rays or other radio waves, or may be an external connection apparatus 50 compatible with operations of the information processing apparatus 100, such as a portable phone.

The input apparatus 108 includes an input control circuit that generates an input signal on the basis of information input by the user and outputs the input signal to the CPU 101. The user operates this input apparatus 108 to thereby input various types of data into the information processing apparatus 100 or instruct the information processing apparatus 100 to perform a processing operation.

The output apparatus 109 is constituted by an apparatus capable of notifying the user of acquired information by the use of a sense such as a sense of sight, a sense of hearing, and a sense of touch. The output apparatus 109 can be, for example, a display apparatus such as a liquid crystal display (LCD) and an organic electro-luminescence (EL) display, an audio output apparatus such as a speaker and headphones, a vibrator, or the like.

The output apparatus 109 outputs results obtained by the processing of the information processing apparatus 100, as pictures such as texts and images, sounds such as speech and acoustic sounds, vibrations, or the like.

The storage apparatus 110 is an apparatus for storing data, which is configured as an example of the storage unit of the information processing apparatus 100. The storage apparatus 110 is constituted by, for example, a magnetic storage device such as a hard disk drive (HDD), a semiconductor storage device, an optical storage device, a magneto-optical storage device, and the like. The storage apparatus 110 stores, for example, programs and various types of data to be executed by the CPU 101, various types of data externally acquired, and the like.

The drive 111 is a reader/writer for the removable recording medium 40 such as a magnetic disk, an optical disc, a magneto-optical disk, and a semiconductor memory. The drive 111 is built in the information processing apparatus 100 or externally connected to the information processing apparatus 100.

The drive 111 reads information recorded on the mounted removable recording medium 40 and outputs the information to the RAM 103. Moreover, the drive 111 writes records on the mounted removable recording medium 40.

A connection port 112 is a port for connecting an apparatus to the information processing apparatus 100. The connection port 112 can be, for example, a universal serial bus (USB) port, an IEEE1394 port, a small computer system interface (SCSI) port, or the like.

Moreover, the connection port 112 may be an RS-232C port, an optical audio terminal, a high-definition multimedia interface (HDMI)® port, or the like. By connecting the external connection apparatus 50 to the connection port 112, various types of data are exchanged between the information processing apparatus 100 and the external connection apparatus 50.

The communication apparatus 113 is, for example, a communication interface constituted by a communication device for connecting to the network N and the like. The communication apparatus 113 can be, for example, a local area network (LAN), Bluetooth®, Wi-Fi, a communication card for a wireless USB (WUSB), or the like.

Alternatively, the communication apparatus 113 may be a router for optical communication, a router for an asymmetric digital subscriber line (ADSL), various modems for communication, or the like. The communication apparatus 113 sends and receives, for example, signals and the like by using a predetermined protocol such as TCP/IP to/from the Internet or another communication apparatus.

Moreover, the network N connected to the communication apparatus 113 is a network connected with a wire or wirelessly, and can include, for example, the Internet, a household LAN, infrared communication, radio communication, satellite communication, and the like. The communication unit 13 may be the communication apparatus 113.

The imaging apparatus 114 is, for example, an apparatus that captures an image of a real space and generates the captured image by using various members an image pickup element such as a complementary metal oxide semiconductor (CMOS) and a charge coupled device (CCD), a lens for controlling imaging of an image of an object on the image pickup element, and the like. The imaging apparatus 114 may capture still images or may capture moving images.

The sensor 115 includes, for example, various sensors such as an acceleration sensor, an angular velocity sensor, a geomagnetic sensor, an illuminance sensor, a temperature sensor, an atmospheric pressure sensor, and a sound sensor (microphone). The sensor 115 acquires, for example, information about the state of the information processing apparatus 100 itself, such as an attitude of a casing of the information processing apparatus 100 and information about the surrounding environment of the information processing apparatus 100, such as brightness and noise in the periphery of the information processing apparatus 100.

Moreover, the sensor 115 may include a GPS receiver that receives global positioning system (GPS) signals and measures latitude, longitude, and altitude of the apparatus.

Hereinabove, the configuration example of the information processing system 1 has been shown. Each of the above-mentioned components may be configured by using a general-purpose members or may be configured by using a member specialized for the function of each component. Such a configuration can be changed as appropriate in accordance with the state-of-the-art at each time when the configuration is carried out.

[Operation of Information Processing System]

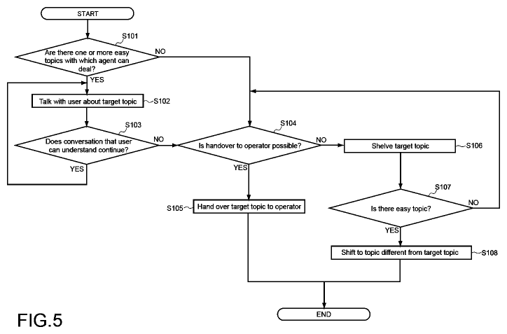

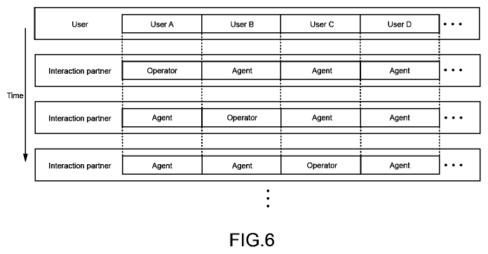

FIG. 5 is a flowchart showing the overall processing flow of the information processing system 1. FIG. 6 is a conceptual diagram showing the interaction partner of each of a plurality of users in time series and is a diagram describing a schedule in which the operator interacts with the user.

In the information processing system 1 according to this embodiment, as shown in FIG. 6, the interaction between a user and an operator and the interaction between a user different from the user and an agent are simultaneously performed on the basis of a schedule in which how long and which of the plurality of users the operator will interact with has been preset. Hereinafter, setting the user B of the plurality of users as a representative, an example of an operation of the information processing system 1 in a case where the user B interacts with the agent and the operator will be described referring to FIG. 4 as appropriate.

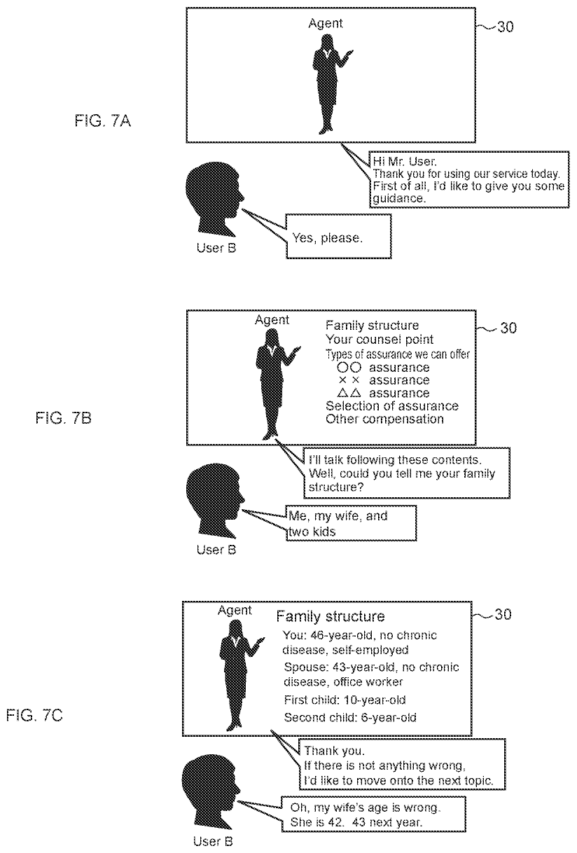

FIGS. 7 to 11 are diagrams showing an example of a display screen of the terminal device 20. First of all, the user B connects the terminal device 30 to the information processing apparatus 10 in communication with each other and performs predetermined log-in processing. At this time, the control unit 11 outputs a specific display screen to the terminal device 30 and activates the agent 11a.

Accordingly, an avatar image of the agent 11a is displayed on the terminal device 30 (FIG. 7a), and the agent 11a refers to the storage unit 12 and utters a preset sentence to the user B (FIG. 7b).

Here, in a case where there are one or more topics having the difficulty level lower than a predetermined threshold among topics that the agent 11a can present to the user B (YES in Step S101), the agent 11a proceeds with the interaction in a question-and-answer format about the topics having the difficulty level lower than the predetermined threshold until the operator appears, and collects information from the user B (Step S102). At this time, the terminal device 30 of the user B explicitly shows about which topic the interaction proceeds. It should be noted that while the user B is interacting with the agent, as shown in FIG. 6, a user (e.g., user A) different from the user B is interacting with the operator.

Subsequently, the agent 11a proceeds with the interaction while checking with the user whether or not the information acquired from the user is correct. At this time, the information obtained from the user is displayed on the terminal device 30 (FIG. 7c), and if a simple correction that the agent 11a is capable of handling is found, then the agent 11a performs the correction.

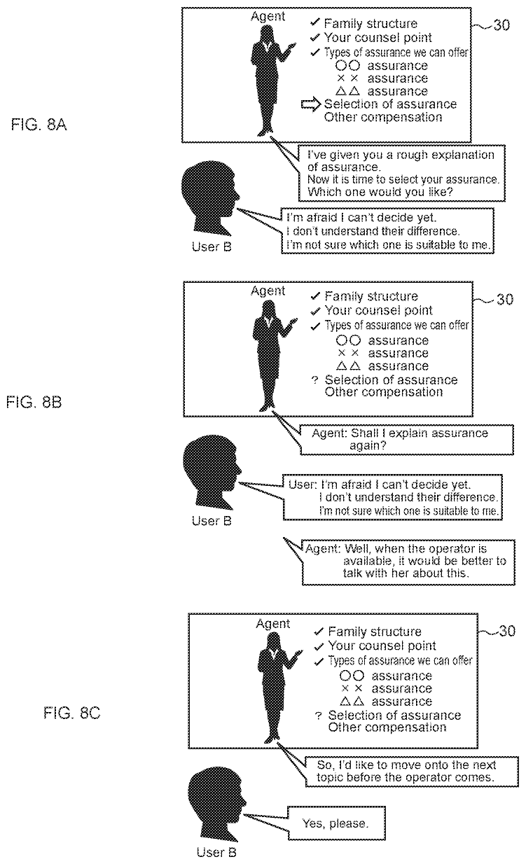

Subsequently, in a case where the agent 11a has not proceeded with the interaction with the user B about the specific topic (NO in Step S103 in FIG. 8a) and, for example, the interaction between the operator and the user (e.g., user A) different from user B has not been finished and the topic cannot be handed over to the operator (NO in Step S104), the agent 11a notifies the user of deferring (shelving) the specific topic (Step S106 in FIG. 8b). At this time, in a case where there are one or more topics having the difficulty level lower than the predetermined threshold among topics different from the topics presented to the user B in the previous step S102 (Yes in Step S107), the agent 11a notifies the user B of shifting to those topics (Step S108 in FIG. 8c).

As a condition for deferring the topic, the agent 11a cannot understand what the user B said and repeatedly asks the user B to say the same thing again many times or the agent 11a repeats the same utterance many times. Alternatively, the topic may be shelved also in a case where the user B is getting angry or irritated by the agent 11a.

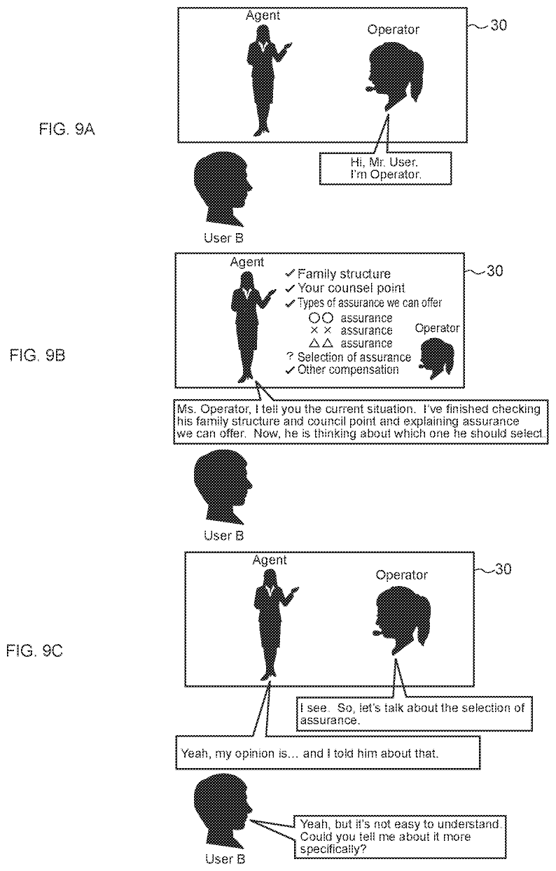

On the other hand, in a case where the agent 11a has not proceeded with the interaction with the user B about the specific topic (NO in Step S103 in FIG. 8a) and, for example, the interaction between the operator and the user (e.g., user A) different from the user B has been finished and the topic can be handed over to the operator (YES in Step S104), the control unit 11 causes the terminal device 30 to display an avatar image of the operator (FIG. 9a) and the agent 11a transmits a progress status related to the deferred topic to the operator (Step S105 in FIG. 9b).

Accordingly, the operator can know the progress status of the interaction between the user B and the agent about the specific topic without interacting with the user B at all, and therefore the workload of the operator is greatly reduced. Moreover, since it is unnecessary to interact with each of the plurality of users all the time, an improvement in operational efficiency can be achieved.

The agent 11a explains the details of the explanation finished at the present time and the situation and presents the items to the terminal device 30 at the same time. At this time, the operator checks at hand the information while seeing the same screen as that the user is seeing (see FIG. 4).

The operator then notifies the agent 11a of explaining more specifically the topic shelved in the previous step S106. The agent 11a then communicates to the operator how far the agent 11a has explained the topic to the user (FIG. 9c). Accordingly, the interaction between the agent 11a and the operator is opened to the user, and the user can know how far the agent 11a and the operator understand it and feel easy. At this time, in the information processing system 1 according to this embodiment, the user may interrupt the interaction between the agent 11a and the operator (FIG. 9c). Accordingly, the operator can understand the context of the interaction, recognize the intention of the user, and then start the interaction smoothly.

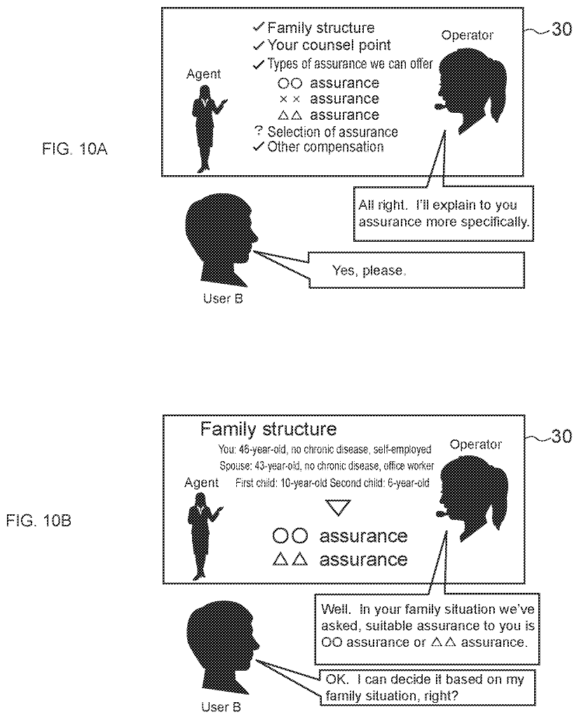

Subsequently, the control unit 11 expresses the fact that handover to the operator has been finished, by the screen and the utterance. At this time, the agent 11a remains on the screen, and prepares for handover in a case where the operator disappears by keeping listening to the interaction between the operator and the user, as shown in FIG. 10a.

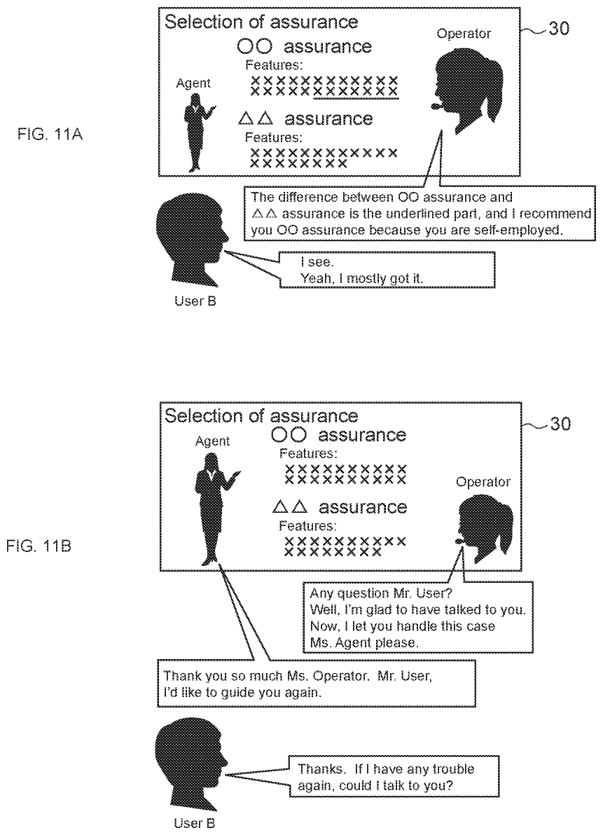

Next, the operator sees the information collected by the agent 11a at hand, presents the information to the terminal device 30, and proceeds with the interaction (FIG. 10b). Information that the agent 11a has got from the user before the appearance of the operator is presented on the display screen of the terminal device 30 (FIG. 11a). At this time, while the user B is interacting with the operator, as shown in FIG. 5, the user different from the user B is interacting with the agent 11a as in the previous steps S101 to S103.

Next, in a case where the user is convinced with the topic shelved in the previous step S106, the control unit 11 switches the operator to the agent 11a as a partner who interacts with the user (FIG. 11b). In this case, it is also possible to contribute to earn the user's trust by using an expression in which the agent 11a figures out the right timing to switch from the operator rather than being switched by the operator.

### Second Embodiment

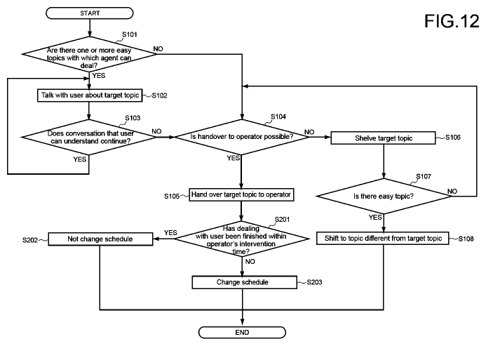

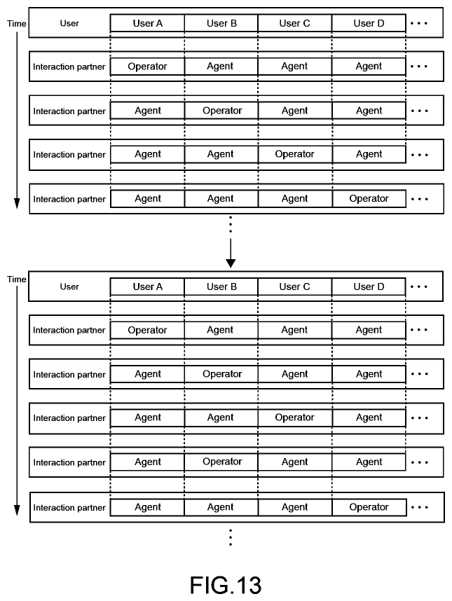

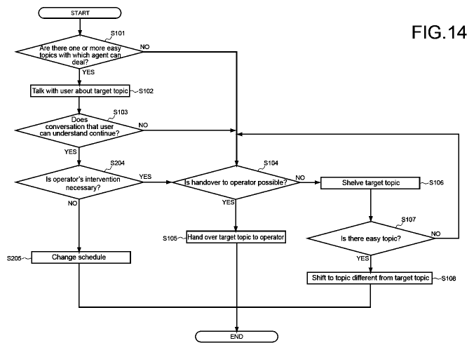

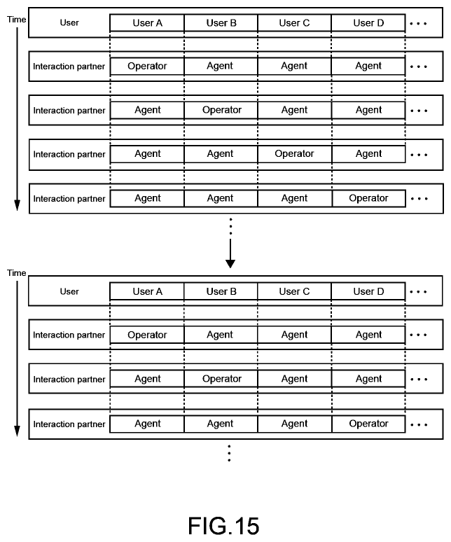

FIGS. 12 and 14 are flowcharts showing the overall processing flow of the information processing system 1 of a second embodiment. FIGS. 13 and 15 are conceptual diagrams showing interaction partners of the plurality of users in time series in the second embodiment and are diagrams showing a schedule for the operator to interact with the users.

The second embodiment is different from the first embodiment in that, in a case where the partner who interacts with the user switches from the agent 11a to the operator, the switching timing to the operator is rescheduled when the switching timing needs to be modified so that the entire system is optimized. Hereinafter, some points of an operation of an information processing system 1 according to the second embodiment will be described referring to FIGS. 12 and 14 as appropriate. It should be noted that steps similar to those of the first embodiment will be denoted by similar reference signs and descriptions thereof will be omitted.

[Application Example 1]

In the previous step S105, the agent 11a communicates to the operator the progress status of the deferred topic, and in a case where the interaction between the operator and the user B about the topic has been finished within a predetermined time (YES in Step S201), the interaction between each user and the operator is performed following the preset schedule (FIG. 6) (Step S202).

On the other hand, in the previous step S105, the agent 11a communicates the progress status related to the deferred topic to the operator, and in a case where the interaction between the operator and the user B about the topic has not been finished within the predetermined time (Step S201), the preset schedule (FIG. 6) is rescheduled (Step S203).

Specifically, for example, in a case where the interaction between the user B and the operator has not finished as scheduled, as shown in FIG. 13, the interaction between the user B and the agent 11a is terminated as originally scheduled, and the interaction between the user C and the operator, which has been scheduled immediately after the user B, is performed as scheduled. Then, the operator intervenes before interacting with the user D, and a continuation of the interaction between the operator and the user B, which has not been finished as scheduled, is performed.

[Application Example 2]

For example, in a case where the interaction between the agent 11a and the user C proceeds about the specific topic (YES in S103) and the operator's intervention is unnecessary (NO in the Step S204), the preset schedule (FIG. 6) is rescheduled (Step S205).

Specifically, for example, the interaction between the operator and the user C is canceled and the interaction between the user D and the operator is performed instead. Then, users following the user D are moved up in order and the interaction with the operator is performed.

### Modified Examples

Hereinabove, the embodiments of the present technology have been described, though the present technology is not limited to the above-mentioned embodiments. Various modifications can be made as a matter of course.

For example, in the above-mentioned embodiments, in a case where the partner who interacts with the user switches from the agent to the operator or from the operator to the agent, the size of the avatar may be changed to clarify who is speaking. In addition, the utterance sound of the agent and the operator may be set to be clearly different and switching of the speaker may be clearly expressed also by the sounds.

### Supplements

Embodiments of the present technology can include, for example, the information processing apparatus and the system as described above, an information processing method to be performed in the information processing apparatus or the system, a program that causes the information processing apparatus to function, and a non-transitory tangible medium on which the program has been recorded.

Moreover, the above embodiments have been described on the premise that the information processing system 1 suggests an assurance plan to the user, though not limited thereto. The applications of the present technology are not particularly limited.

In addition, the effects described in this specification are merely illustrative or exemplary and not limitative. That is, in addition to or instead of the above-mentioned effects, the present technology can provide other effects obvious to a person skilled in the art in light of the descriptions in this specification.

Although the favorable embodiments of the present technology have been described above in detail with reference to the accompanying drawings, the present technology is not limited to such examples. It is obvious that a person having an ordinary skill in the art of the present technology can conceive various variants or modifications within the scope of the technical ideas described in the scope of claims, and it should be understood that these variants or modifications also fall within the technical scope of the present technology as a matter of course.

It should be noted that the present technology may also take the following configurations.

(1)

An information processing apparatus that is connected to be capable of communicating with a terminal apparatus of a user and a terminal apparatus of an operator who interacts with the user and that has an agent that performs information exchange with the user about a specific topic, comprising
a control unit that causes the terminal apparatus of the user to display a situation where the agent is communicating a progress status of the information exchange to the operator.

(2)

The information processing apparatus according to (1), in which
the control unit causes the agent to utter the progress status of the information exchange to the operator.

(3)

The information processing apparatus according to (2), in which
the control unit receives audio information from the user while the agent is communicating the progress status to the operator by the utterance.

(4)

The information processing apparatus according to any one of (1) to (3), in which
the control unit determines whether or not to cause the agent to communicate the progress status to the operator on the basis of audio information regarding the specific topic from the user.

(5)

The information processing apparatus according to (4), in which
the control unit causes, in a case where the control unit determines to cause the agent to communicate the progress status to the operator on the basis of the audio information regarding the specific topic from the user, to temporarily stop the information exchange and performs processing of shifting to a topic different from the specific topic.

(6)

The information processing apparatus according to any one of (1) to (5), in which
the control unit
   causes the terminal apparatus of the user to display an avatar image of the agent and an avatar image of the operator, and
   causes the terminal apparatus of the user to display a situation where the avatar image of the agent is communicating the progress status to the avatar image of the operator.

(7)

The information processing apparatus according to any one of (1) to (6), in which
the control unit causes the terminal apparatus of the operator to display at least one of a history of the information exchange between the user and the agent or information displayed on the terminal apparatus of the user during the information exchange between the user and the agent.

(8)

An information processing system, including:
a terminal apparatus of a user;
a terminal apparatus of an operator who interacts with the user; and
an information processing apparatus that is connected to be capable of communicating with the terminal apparatus of the user and the terminal apparatus of the operator and that has an agent that performs information exchange with the user about a specific topic, the information processing apparatus including a control unit that causes the terminal apparatus of the user to display a situation where the agent is communicating a progress status of the information exchange to the operator.

(9)

An information processing method, including:
by an information processing apparatus,
performing information exchange with a user about a specific topic; and
causing a terminal apparatus of the user to display a situation where an agent is communicating a progress status of the information exchange to the operator.

(10)

A program that causes an information processing apparatus to execute:
a step of performing information exchange with a user about a specific topic; and
a step of causing a terminal apparatus of the user to display a situation where an agent is communicating a progress status of the information exchange to the operator.

### REFERENCE SIGNS LIST

1 information processing system

10, 100 information processing apparatus

11 control unit

11a agent

12 storage unit

13 communication unit

20, 30 terminal apparatus

1. An information processing apparatus that is connected to be capable of communicating with a terminal apparatus of a user and a terminal apparatus of an operator who interacts with the user and that has an agent that performs information exchange with the user about a specific topic, comprising
a control unit that causes the terminal apparatus of the user to display a situation where the agent is communicating a progress status of the information exchange to the operator.

2. The information processing apparatus according to claim 1, wherein
the control unit causes the agent to utter the progress status of the information exchange to the operator.

3. The information processing apparatus according to claim 2, wherein
the control unit receives audio information from the user while the agent is communicating the progress status to the operator by the utterance.

4. The information processing apparatus according to claim 1, wherein
the control unit determines whether or not to cause the agent to communicate the progress status to the operator on a basis of audio information regarding the specific topic from the user.

5. The information processing apparatus according to claim 4, wherein
the control unit causes, in a case where the control unit determines to cause the agent to communicate the progress status to the operator on a basis of the audio information regarding the specific topic from the user, to temporarily stop the information exchange and performs processing of shifting to a topic different from the specific topic.

6. The information processing apparatus according to claim 1, wherein
the control unit
causes the terminal apparatus of the user to display an avatar image of the agent and an avatar image of the operator, and
causes the terminal apparatus of the user to display a situation where the avatar image of the agent is communicating the progress status to the avatar image of the operator.

7. The information processing apparatus according to claim 1, wherein
the control unit causes the terminal apparatus of the operator to display at least one of a history of the information exchange between the user and the agent or information displayed on the terminal apparatus of the user during the information exchange between the user and the agent.

8. An information processing system, comprising:
a terminal apparatus of a user;
a terminal apparatus of an operator who interacts with the user; and
an information processing apparatus that is connected to be capable of communicating with the terminal apparatus of the user and the terminal apparatus of the operator and that has an agent that performs information exchange with the user about a specific topic, the information processing apparatus including a control unit that causes the terminal apparatus of the user to display a situation where the agent is communicating a progress status of the information exchange to the operator.

9. An information processing method, comprising:
by an information processing apparatus,
performing information exchange with a user about a specific topic; and
causing a terminal apparatus of the user to display a situation where an agent is communicating a progress status of the information exchange to the operator.

10. A program that causes an information processing apparatus to execute:
a step of performing information exchange with a user about a specific topic; and
a step of causing a terminal apparatus of the user to display a situation where an agent is communicating a progress status of the information exchange to the operator.
